(19) United States
(12) Patent Application Publication
(10) Pub. No.: US 2011/0089007 A1
(43) Pub. Date: Apr. 21, 2011

(54) MECHANICAL BUTTON SEAMLESSLY INTEGRATED INTO A SMOOTH SURFACE

(76) Inventors: CHRISTOPHER FRUHAUF, San Francisco, CA (US); Joseph J. Kopp, JR., Fairfield, CA (US); Robert Brunner, San Francicso, CA (US); Peter Fornell, Lake Oswego, OR (US)

(21) Appl. No.: 12/905,983

(22) Filed: Oct. 15, 2010

Related U.S. Application Data
(60) Provisional application No. 61/252,112, filed on Oct. 15, 2009.

(51) Int. Cl. H01H 13/14

(52) U.S. Cl. 200/341

(57) ABSTRACT

A button mechanism for effecting user inputs to an electronic device. The button mechanism includes a frame top that has a rigid frame portion; and flexible frame portion. The button mechanism further includes a device body that is oriented substantially parallel to the frame top and a button assembly that is situated between the device body and the frame top. The button assembly includes a contact portion that is operable to provide an electronic signal to control circuitry for the electronic device. The button assembly is affixed to an upper portion of the device body. The mechanism further includes a switch attached to the button assembly on the contact portion and a spring portion having a stepwise shape. The spring portion has an upper horizontal step portion and a lower horizontal step portion. The lower horizontal step portion of the spring is affixed to the button assembly. The upper horizontal step portion is disposed above the switch and below the flexible frame portion such that, upon application of a downward pressure to the flexible frame, the upper horizontal step portion is deformed downward to bring the upper horizontal step portion in contact with the switch, causing an electronic signal to be sent to the control circuitry of the electronic device.

### CROSS-REFERENCE TO RELATED APPLICATION

This application claims benefit of U.S. Provisional Application No. 61/252,112, filed Oct. 15, 2009, which is hereby incorporated by reference.

### FIELD OF INVENTION

This invention relates to mechanical buttons used to control user inputs to electronic devices.

### BACKGROUND OF THE INVENTION

Electronic devices typically include controls that require input by a user, for example input by the user pressing a button or squeezing a portion of the device. Well-designed controls accept intentional user input, provide user feedback, and avoid accidental activation. Mechanical buttons have conventionally provided a design solution for such controls. However, the use of mechanical buttons typically requires a manufacturer to assemble multiple, separate parts into the surface of the device's frame. Such manufacturing also requires precise molding to reduce gaps and careful color matching of the separate parts to achieve an aesthetic appearance. As a result, the surface of the device can be uneven and susceptible to the entry of dirt and breakage because of the use of separate parts.

### BRIEF SUMMARY OF THE INVENTION

In accordance with a first aspect of the present invention, a button mechanism for effecting user inputs to an electronic device is provided. The button mechanism includes: (a) a frame top comprising: (i) a rigid frame portion; and (ii) a flexible frame portion; (b) a device body, oriented substantially parallel to the frame top; (c) a button assembly, situated between the device body and the frame top, the button assembly including a contact portion operable to provide an electronic signal to control circuitry for the electronic device, the button assembly being affixed to an upper portion of the device body; (d) a switch attached to the button assembly on the contact portion; and (e) a spring portion having a stepwise shape and comprising an upper horizontal step portion and a lower horizontal step portion; the lower horizontal step portion being affixed to the button assembly. The upper horizontal step portion is disposed above the switch and below the flexible frame portion such that, upon application of a downward pressure to the flexible frame, the upper horizontal step portion is deformed downward to bring the upper horizontal step portion in contact with the switch, causing an electronic signal to be sent to the control circuitry of the electronic device.

In accordance with a second aspect of the present invention, a linear button mechanism for effecting user inputs to an electronic device is provided. The button mechanism includes: (a) a frame top comprising: (i) a rigid frame portion; and (ii) a first flexible frame portion and a second flexible frame portion; (b) a device body, oriented substantially parallel to the frame top; (c) a button assembly, situated between the device body and the frame top, the button assembly including first and second contact portions, each operable to provide an electronic signal to control circuitry for the electronic device, the button assembly being affixed to an upper portion of the device body; (d) a first switch attached to the button assembly on the first contact portion and a second switch attached to the button assembly on the second contact portion; and (e) a spring portion having a stepwise shape and comprising a first upper horizontal step portion, a lower horizontal step portion and a second horizontal upper step; the lower horizontal step portion being affixed to the button assembly. The first upper horizontal step portion is disposed above the first switch and below the first flexible frame portion, and the second upper horizontal step portion is disposed above the second switch and below the second flexible frame portion such that, upon application of a downward pressure to the first flexible frame, the first upper horizontal step portion is deformed downward to bring the first upper horizontal step portion in contact with the first switch, causing an electronic signal to be sent to the control circuitry of the electronic device and, upon application of a downward pressure to the second flexible frame, the second upper horizontal step portion is deformed downward to bring the second upper horizontal step portion in contact with the second switch, causing an electronic signal to be sent to the control circuitry of the electronic device.

In accordance with a third aspect of the present application, a button mechanism for controlling user inputs to an electronic device is provided. The button mechanism includes: (a) a frame top comprising: (i) a rigid frame portion; and (ii) a flexible frame portion; (b) a device body, oriented substantially parallel to the frame top; (c) a button assembly, situated between the device body and the frame top, the button assembly including a contact portion operable to provide an electronic signal to control circuitry for the electronic device, the button assembly being affixed to an upper portion of the device body; and (d) a switch attached to the button assembly on the contact portion. The switch is disposed below the flexible frame portion such that, upon application of a downward pressure to the flexible frame, the flexible frame portion is deformed downward to contact the switch, causing an electronic signal to be sent to the control circuitry of the electronic device, and upon release of the downward pressure, the upper horizontal step portion springs back so as to release contact with the switch.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a cross-sectional view of a mechanical button mechanism seamlessly integrated into a smooth surface of an electronic device's housing;

FIG. 2 is a top view of an electronic device incorporating two mechanical button mechanisms in a seamless frame surface of the electronic device;

FIG. 3 is a top view of an electronic device incorporating four mechanical button mechanisms in a seamless frame surface of the electronic device;

FIG. 4 is a cross-sectional view of a two mechanical button mechanism; and

FIG. 5 is an exploded parts view of a two mechanical button mechanism example of FIG. 4.

### DETAILED DESCRIPTION OF THE INVENTION

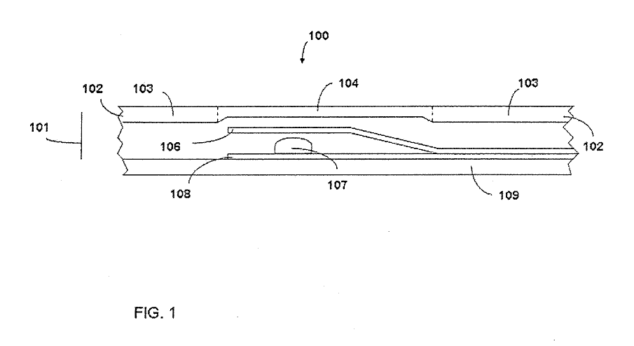

The structure and operation of a mechanical button in accordance with the present invention will be described in relation to FIG. 1. FIG. 1 is a cross-sectional view of a portion of an electronic device housing 100 that includes the mechanical button. The housing includes a frame top 102, which includes rigid frame 103 portion and a flexible frame 104 portion. Preferably, rigid frame 103 and flexible frame 104 are seamlessly integrated into a single, smooth surface, for example forming the top surface of an electronic device.

In accordance with the illustrated embodiment, rigid frame 103 is thicker than flexible frame 104 and does not flex. Flexible frame 104 is thinner than rigid frame 103 and does flex. Flexible frame 104 provides frame top 102 with a flex property that allows the mechanical action of user-input activity to be accepted, i.e., by depression of a portion of the flexible frame, e.g., by the fingers of the user of the electronic device.

In accordance with a preferred embodiment, the material composition of the rigid frame 103 and flexible frame 104 can be a polycarbonate plastic, although other materials may be used. The material composition of rigid frame 103 and flexible frame 104 is not intended to be limited to polycarbonates. In a preferred embodiment, rigid frame portion 103 and flexible frame portion 104 are formed of the same material. However, the invention is not limited to such a configuration and it is contemplated that different materials may be distributed throughout the surface of the top frame 102 to provide the difference in flexibility between the flexible frame 104 and the rigid frame 103.

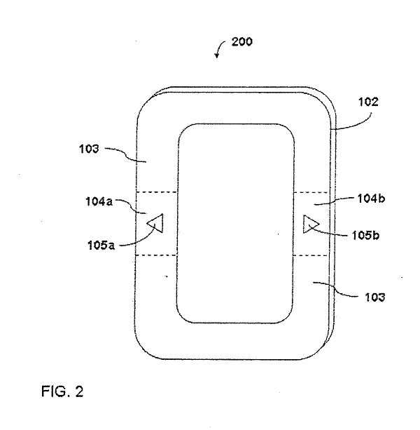

A superficial control mark (not shown in FIG. 1, but visible in FIGS. 2-4 discussed below) may be located on the exterior surface of flexible frame 104 to serve as a visual and tactile target for user-input activity, to guide the user as to where to press the surface of the top frame 102 during use of the electronic device.

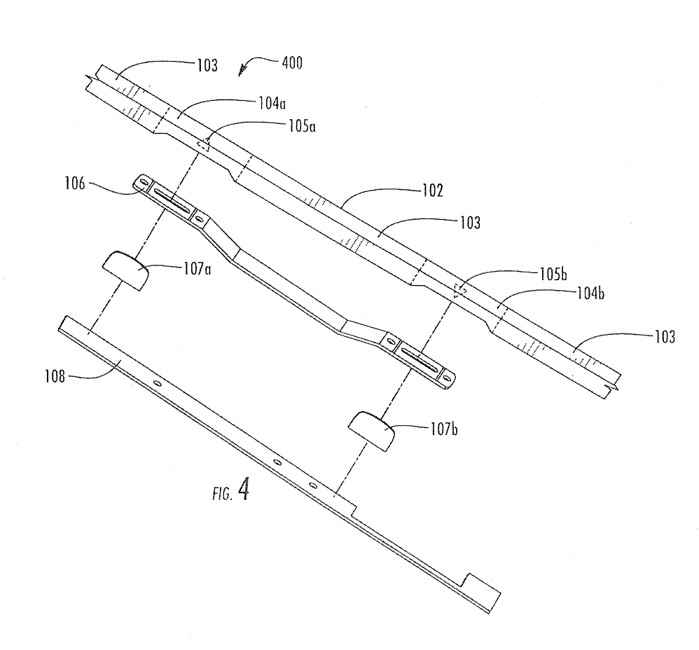

The button mechanism in accordance with the illustrated embodiment also includes a metal spring 106, which is situated below flexible frame 104 in the interior of electronic device housing 100. The metal spring 106 preferably has a narrow, step-wise, rectangular, “leaf-spring” shape with at least one upper horizontal step and a lower horizontal step interposed by a diagonal rise. Although only one upper horizontal step is shown in FIG. 1, the spring may include an additional upper horizontal step, for example at the other end of the metal spring 106, which would allow the metal spring to function with two mechanical buttons. Such a configuration will be discussed further below in connection with FIG. 4.

The metal spring 106 provides a mechanism for transferring the mechanical action of user-input activity from the flexible frame 104 to a dome switch 107. Utilization of the metal spring between the flexible frame 104 and the dome switch, rather than have the depressed flexible frame 104 directly contact and activate the dome switch 107, advantageously compensates for tolerances in the manufacturing of the flexible frame 104 and the rigid frame 103. For example, inclusion of the metal spring 106 allows for a greater or lesser degree of flex in the flexible frame 104, while still achieving the function of properly activating the dome switch 107. The use of the metal spring 106 between the flexible frame 104 and the dome switch 107 also provides a consistent feel for the electronic device when in use, and particularly when using the controls employing the mechanical button. While the exemplary embodiment employs a metal spring, the invention is not intended to be limited to a metal spring, and the spring can be made of other materials, such as plastic, having the desired spring characteristics.

The dome switch 107 is disposed below the upper step of the metal spring 106 in the electronic device housing 100 and provides a switch mechanism that accepts the mechanical action of the metal spring 106, which causes the dome switch 107 to complete an electrical circuit, as discussed further below. The dome switch 107 preferably also flexes and generates a click sound when flexed. A dome switch is preferred because it provides a firm, audible feedback upon activation and is suitable for high-volume use. The embodiment of the invention is not, however, intended to be limited to a dome switch. A different type of switch, such as a piezoelectric switch, may be used in the embodiment of the invention instead of a dome switch.

A button assembly 108 is provided in a layer situation below the metal spring 106 and above the device body 109 within the electronic device housing 100. The button assembly 108 preferably has a narrow, flat rectangular shape that substantially aligns with the metal spring 106. In the illustrated embodiment, both the lower horizontal portion of the metal spring 106 and the dome switch 107 are attached to the button assembly 108, while the button assembly 108 is attached to the device body 109. The dome switch 107 is attached to the button assembly 108 directly below the upper step of the metal spring 106. The metal spring 106 is attached by its lower step to the button assembly 108 opposite the dome switch 107. This configuration allows the upper step of the metal spring 106 to flex and come into contact with and activate the dome switch 107, while the lower step of the metal spring 106 does not move relative to the other elements in the mechanism 101. The resilience of the metal spring 106 causes the upper step to return to its unflexed state once the flexible frame 104 is no longer being depressed by the user.

In a preferred embodiment, the dome switch 107 is mounted on a flexible printed circuit board (PCB) incorporated in the button assembly 108. The PCB includes portions located so as to receive an input upon depression of the dome switch and to provide an electrical connection to other circuits in the electronic device housing 100, such as a processor controlling the electronic device. The embodiment of the invention is not intended to limit the electrical connection mechanism to a flexible PCB in button assembly 108. For example, the PCB could be located remotely with depression of the dome switch 107 causing a signal to be sent to the remote PCB.

FIG. 1 illustrates a single mechanical button mechanism 101 that includes the combination of flexible frame 104, metal spring 106, dome switch 107, and button assembly 108 integrated into frame top 102 that has a single, smooth, seamless surface.

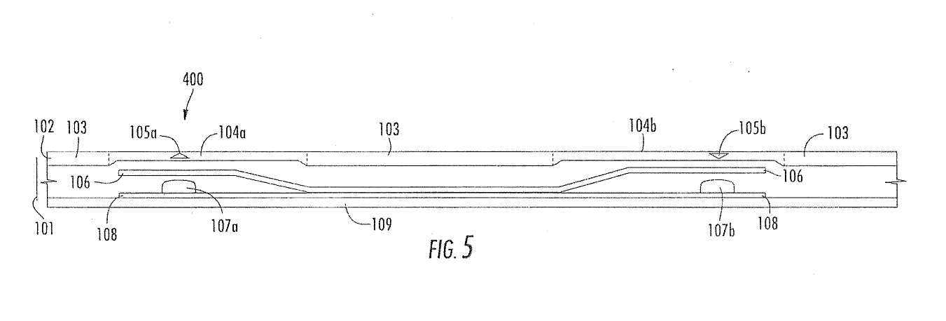

As would be understood, in control electronic devices, there can be more than one mechanical button mechanism that accepts user-input activity and results in the transmission of different commands to an electronic device. In accordance with a preferred embodiment, more than one mechanical button mechanism may be integrated linearly in a flexible frame. For example, the metal spring 106 may include an additional diagonal rise to another horizontal upper step, which can function in another instance of the button mechanism, allowing two button mechanisms to share a common spring element. Such an embodiment is shown and described below in more detail with reference to FIGS. 4 and 5.

In a preferred embodiment of mechanical button mechanism 101 a superficial control mark is provided on the surface of flexible frame 104 (not shown in FIG. 1). The control mark provides a visual and tactile target for a device user so the user knows where to press.

FIG. 2 is a representation of an electronic device that includes plural instances of a preferred embodiment of the mechanical button mechanism 101 of the present invention, employed in the top frame surface of the electronic device. As shown in FIG. 2, the outer surface of frame top 102 is divided into a rigid frame area 103 interposed by a flexible frame 104a on the left-hand side and a flexible frame 104b on the right-hand side of the device. A control mark 105a is located on the surface of the flexible frame 104a and another control mark 105b is located on the surface of the flexible frame 104b. The control marks preferably include a visual indication of function, such as an arrow head, as well as a tactile indication, such as a bump or otherwise raised portion of the top surface of the device. The tactile indication can be especially helpful in allowing the user to maintain his or her fingers on the flexible frame portions 104a and 104b when it is desired to enter a control command into the device.

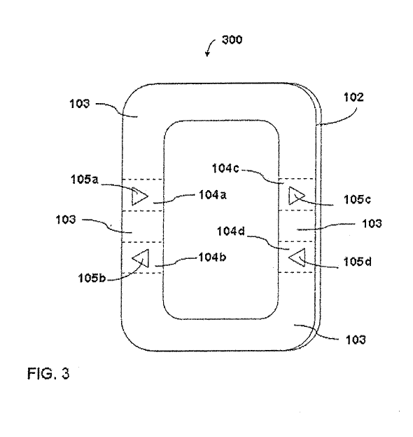

In the electronic device 200 shown in FIG. 2, two mechanical buttons are provided, on opposite sides of a frame top 102. The exemplary representation of FIG. 2 is not intended to limit the number or location of mechanical buttons in a frame. There could be two or more mechanical buttons integrated linearly on each side of a frame, as illustrated in FIG. 3.

FIG. 3 illustrates plural mechanical buttons in accordance with the present invention utilized in an electronic book (eBook) device 300. In the illustrated embodiment, two pairs of mechanical buttons are located on each of opposite sides of a frame top 102. In embodiment illustrated in FIG. 3, four user-input structures enable a user to activate commands to control the example eBook.

For example, the four user-input structures may represent page forward and page back control marks. Thus in the illustrated example, on the left-hand side of the example eBook in flexible frame 104a are the page forward control mark 105a and page back control mark 105b user-input structures. On the right-hand side of the example eBook in flexible frame 104b are the page forward control mark 105c and page back control mark 105d user-input structures.

Control marks 105a and 105b are arranged linearly in flexible frame 104a, as are the underlying parts of the mechanical button mechanisms corresponding to 105a and 105b, for example as described below with reference to FIGS. 4 and 5. Similarly, control marks 105c and 105d are arranged linearly in flexible frame 104b, as are the underlying parts of the mechanical button mechanisms corresponding to 105c and 105d. An example of two switches arranged linearly in this fashion is shown in FIGS. 4 and 5.

FIG. 4 shows an exploded parts view and FIG. 5 a cross-sectional view of a two mechanical button mechanism example 400. In these figures, two buttons are arranged linearly. In the exploded parts view of FIG. 4, the parts are illustrated in relative vertical position to each other with some parts shown tilted forward for a clearer view. As assembled, the parts are arranged as shown in FIG. 5.

In FIGS. 4 and 5, the frame top 102 includes a rigid frame 103 interposed by a flexible frame 104a and a control mark 105a on one end, and a flexible frame 104b and a control mark 105b on the other end. A metal spring 106 is situated below the frame top 102. The metal spring 106 has a first upper step situated below the flexible frame 104a on one end, and a second upper step extending in the opposite direction, below the flexible frame 104b on the other end.

The lower step of the metal spring 106 is situated below the section of rigid frame 103 that is interposed between the flexible frame 104a and the flexible frame 104b. Below the first upper step of metal spring 106 on one end is a dome switch 107a. Below the upper step of metal spring 106 on the opposite end is a dome switch 107b. Below the dome switch 107a and the dome switch 107b is a button assembly 108, with the dome switch 107a being situated above a PCB on one end of button assembly 108 and the dome switch 107b being situated above a PCB on an opposite end of button assembly 108.

Operation of the mechanical buttons in the two button example is substantially the same as in the one button illustration of FIG. 1. Specifically, when a user depresses the frame top 102 at either of the control mark 105a or 105b, the corresponding flexible frame, 104a or 104b, moves downward so as to bring the corresponding upper step of the metal spring 106 into engagement with the corresponding dome switch 107a or 107b. When engaged, the dome switch closes, causing a PCB on the button assembly 108 to complete an electrical circuit, causing a signal to be transmitted to inform control circuitry (e.g., a processor) of the electronic device that a user has activated a particular mechanical button mechanism 101.

As discussed in relation to FIG. 1, when the circuit is complete, the dome switch preferably generates a clicking sound to provide the user with positive activation feedback. When the user finishes depressing flexible frame 104a or 104b as the case may be, the flexible frame, and the depressed portion of the metal spring, rebounds upwards to its original position. Rigid frame 103 does not move during user-engagement activities.

As will be understood by those skilled in the art, when multiple mechanical button mechanisms 101 in accordance with the present invention are integrated in a seamless frame top 102, each mechanical button mechanism 101 can correspond to a different signal so that the electronic device can distinguish which mechanical button mechanism 101 the user activated. A processor that controls the electronic device can sense which signal has been received and taken action accordingly, in accordance, for example, with its programming.

For example, in the electronic book (eBook) device shown in FIG. 3 the four user-input structures, indicated on the surface by control marks 105a-105d, enable a user to activate commands to control the eBook. For example, the eBook may be configured so that when a user depresses frame top at control mark 105a, flexible frame 104a moves downward. The downward flex of flexible frame 104a moves an upper wing the underlying mechanical spring downward to activate the dome switch positioned below 105a and 104a in the eBook housing.

Upon positive activation, the dome switch below 105a in the eBook housing generates a click sound, as discussed above. Once the dome switch completes the circuit by contacting the PCB located on the button assembly 108, a signal is transmitted so that the eBook's control circuitry, which can be, for example, a microprocessor or microcontroller. The control circuitry correlates, for example by programming, the switch activation to a page forward command. Similarly, when a user depresses control mark 105d, flexible frame 104d moves downward. The downward flex of flexible frame 104d moves the underlying mechanical spring downward to activate the dome switch positioned below 105d and 104d in the eBook housing. Upon positive activation, the dome switch below 105d in the eBook housing generates a click sound. In this example, upon completion of the circuit, a signal is transmitted to the control circuitry so that the eBook correlates the switch activation to a page back command.

Clearly, the controls executed by the activation of the mechanical buttons are limited only the electrical circuits and programming of the electronic device in which the mechanical buttons are incorporated. In the eBook example discussed above, one set of buttons can be for page forward and page back, while another set of buttons can be for scroll up and scroll down. However, while the button have been described in the context of controlling an eBook, it would be appreciated by one of ordinary skill in the art that the mechanical buttons in accordance with the present invention are in no way limited to the control of an eBook, and can be used to control any device requiring user touch input for the entry of user commands.

In accordance with aspects of the invention as discussed above, a mechanical button is provided that is integrated into a device's frame so that the surface of the frame maintains as a single, smooth surface. The design allows specified parts of the frame to flex while other parts remain rigid. A control may be located in the flexible portion of the frame to accept user input, permitting the mechanical action in the flexed area to activate an underlying switch to complete an electrical circuit and enable a signal to be transmitted to the device.

Moreover, mechanical action in the flexed area also generates a click and tactile feedback to the user. Because there are no separate pieces and no requirement to match separate parts, the device is cheaper to assemble. The smooth, seamless surface provides a better aesthetic appearance and is less prone to dirt infiltration. The smooth, seamless surface also makes the device less susceptible to breakage upon being dropped, enhancing the overall reliability of electronic devices that incorporate the invention.

While the preferred embodiment is described above to include a spring portion between the flexible frame portions and the switches, the invention is not limited to such a configuration. Thus, for example, the buttons may be provided without a spring portion, such that depressing the flexible frame portion directly contacts and depresses the switch, resulting in a control signal being sent.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

What is claimed is:

1. A button mechanism for effecting user inputs to an electronic device, the button mechanism comprising:
(a) a frame top comprising:
(i) a rigid frame portion; and
(ii) a flexible frame portion;
(b) a device body, oriented substantially parallel to the frame top;
(c) a button assembly, situated between the device body and the frame top, the button assembly including a contact portion operable to provide an electronic signal to control circuitry for the electronic device, the button assembly being affixed to an upper portion of the device body;
(d) a switch attached to the button assembly on the contact portion; and
(e) a spring portion having a stepwise shape and comprising an upper horizontal step portion and a lower horizontal step portion; the lower horizontal step portion being affixed to the button assembly,
wherein the upper horizontal step portion is disposed above the switch and below the flexible frame portion such that, upon application of a downward pressure to the flexible frame, the upper horizontal step portion is deformed downward to bring the upper horizontal step portion in contact with the switch, causing an electronic signal to be sent to the control circuitry of the electronic device.

2. The button mechanism according to claim 1, wherein upon release of the downward pressure, the upper horizontal step portion springs back so as to release contact with the switch.

3. The button mechanism according to claim 1, wherein the button assembly has a narrow, flat rectangular shape that substantially aligns with the spring portion.

4. The button mechanism according to claim 1, wherein the switch is a dome switch.

5. The button mechanism according to claim 1, wherein the switch is a piezoelectric switch.

6. The button mechanism according to claim 1, wherein the button assembly includes a flexible PCB that includes the contact portion and the switch is mounted on the contact portion of the PCB.

7. The button mechanism according to claim 1, wherein the electronic device is an electronic book reader.

8. A linear button mechanism for effecting user inputs to an electronic device, the button mechanism comprising:
(a) a frame top comprising:
(i) a rigid frame portion; and
(ii) a first flexible frame portion and a second flexible frame portion;
(b) a device body, oriented substantially parallel to the frame top;
(c) a button assembly, situated between the device body and the frame top, the button assembly including first and second contact portions, each operable to provide an electronic signal to control circuitry for the electronic device, the button assembly being affixed to an upper portion of the device body;
(d) a first switch attached to the button assembly on the first contact portion and a second switch attached to the button assembly on the second contact portion; and
(e) a spring portion having a stepwise shape and comprising a first upper horizontal step portion, a lower horizontal step portion and a second horizontal upper step; the lower horizontal step portion being affixed to the button assembly,
wherein the first upper horizontal step portion is disposed above the first switch and below the first flexible frame portion, and the second upper horizontal step portion is disposed above the second switch and below the second flexible frame portion such that, upon application of a downward pressure to the first flexible frame, the first upper horizontal step portion is deformed downward to bring the first upper horizontal step portion in contact with the first switch, causing a first electronic signal to be sent to the control circuitry of the electronic device and, upon application of a downward pressure to the second flexible frame, the second upper horizontal step portion is deformed downward to bring the second upper horizontal step portion in contact with the second switch, causing a second electronic signal to be sent to the control circuitry of the electronic device.

9. The button mechanism according to claim 8, wherein upon release of downward pressure on either or both of the first and second flexible frame assembly, the respective first and/or second upper horizontal step portion springs back so as to release contact with the first and/or second switch.

10. The button mechanism according to claim 8, wherein the button assembly has a narrow, flat, rectangular shape that substantially aligns with the spring portion.

11. The button mechanism according to claim 8, wherein the first and second switches are dome switches.

12. The button mechanism according to claim 8, wherein the first and second switches are piezoelectric switches.

13. The button mechanism according to claim 8, wherein the button assembly includes a flexible PCB that includes the first and second contact portions and the first and second switches are mounted on the first and second contact portions of the PCB, respectively.

14. A button mechanism for effecting user inputs to an electronic device, the button mechanism comprising:
(a) a frame top comprising:
(i) a rigid frame portion; and
(ii) a flexible frame portion;
(b) a device body, oriented substantially parallel to the frame top;
(c) a button assembly, situated between the device body and the frame top, the button assembly including a contact portion operable to provide an electronic signal to control circuitry for the electronic device, the button assembly being affixed to an upper portion of the device body; and
(d) a switch attached to the button assembly on the contact portion,
wherein the switch is disposed below the flexible frame portion such that, upon application of a downward pressure to the flexible frame, the flexible frame portion is deformed downward to cause the switch to close, causing an electronic signal to be sent to the control circuitry of the electronic device, and upon release of the downward pressure, the switch opens.

15. The button mechanism according to claim 14, wherein the electronic device is an electronic book reader.
